(19) United States
(12) Patent Application Publication
(10) Pub. No.: US 2012/0048681 A1
(43) Pub. Date: Mar. 1, 2012

(54) SYSTEM, GRIPPING HEAD, AND METHOD FOR DISPLACING PRODUCTS

(75) Inventor: Ronald Walter Neutel, Barneveld (NL)

(73) Assignee: ROBOXIS B.V., Barneveld (NL)

(21) Appl. No.: 13/318,541

(22) PCT Filed: May 19, 2010
(86) PCT No.: PCT/NL2010/000085

§ 371 Date: Nov. 2, 2011

(30) Foreign Application Priority Data
May 20, 2009 (NL) 2002912

(51) Int. Cl. B65G 37/00; B25J 11/00; B25J 15/00

(52) U.S. Cl. 198/610; 294/81.51; 414/800

(57) ABSTRACT

A system for displacing products includes: a conveyor (3) for conveying a product (5) in a conveying direction, a gripping device (7) having a moveable gripping head (9) to displace the product from the conveyor to another location, the gripping head includes: a base (32), at least one gripping finger (36) moveably mounted to the base for movement between a gripping position for holding a first side of the product and an open position in which the product is able to pass the at least one gripping finger in a passing direction, where the at least one gripping finger is arranged such that it initially moves away from the product in the passing direction when moving from the gripping position to the open position.

### CROSS-REFERENCE TO RELATED APPLICATIONS

This application is the National Stage of International Application No. PCT/NL2010/000085, filed May 19, 2010, which claims the benefit of Netherlands Application No. 2002912, filed May 20, 2009, the contents of which is incorporated by reference herein.

### FIELD OF THE INVENTION

The invention relates to a system comprising a conveyor for conveying a product in a conveying direction, and a gripping device having a moveable gripping head to displace the product from the conveyor to another location. The gripping head comprises a base, and at least one gripping finger moveably mounted to said base for movement between a gripping position for holding a first side of the product and an open position in which the product is able to pass the at least one gripping finger in a passing direction.

In such systems, the conveyor comprises some kind of supporting element to support the product during conveying and the gripping head generally comprises two gripping fingers that slide/move between the product and the supporting element from opposite sides to grip the product. Subsequently, the gripping head may move the product to above another location and drops/releases the product by rapidly moving the fingers sideways in an opposite direction. The product may be dropped into a container, for instance for packaging reasons.

### BACKGROUND OF THE INVENTION

A drawback of such a gripping head is that it is not able to satisfactory handle sticky products such as cheese, meat products, or other food products. Due to the stickiness of the products there is too much friction between the gripping fingers and the product which may lead to unpredictable and undesirable motion of the products when the gripping fingers move to the open position. It also involves a high risk of damage to the product when the friction is so large that for example the gripping fingers tear the product apart during releasing. An unpredictable and undesirable movement of the products may also occur when moving the gripping fingers from the open position to the gripping position.

The abovementioned effects may increase when the fingers are contaminated by the product itself, more in particular between the product and the gripping finger, or when more contact between the product and gripping head is provided to sufficiently lock the position of the product during a movement of the gripping head. The effects may also increase in case of low-inertia products, wherein a small (frictional) force may already be enough for an undesirable motion of the product. Although some of the effects may be prevented by repeatedly cleaning the gripping head or by replacing a “dirty” gripping head with a clean one, the time it takes to do this reduces the throughput of the machine and may lead to undesired downtime of the system.

Another drawback of the gripping head may be that it is not able to satisfactory handle products which are build up of multiple articles, such as sliced meat products, or adjacent products which have to be packaged as a whole. When one gripping finger holds one article or product, and another gripping finger holds the other article or product, the sideways motion of the gripping fingers may not release the articles or products, but take the articles or products with them or at least induces an unpredictable and undesirable motion. A mutual orientation of the articles or products may also change. As a result, the system has an unpredictable behaviour and a high chance of malfunction or downtime.

Yet another drawback of the gripping head may be that especially in case of thin or small products, the gripping fingers may not be able to slide/move between the product and the supporting element, but the product gets clamped between the gripping fingers, possibly in a wrinkled, wrapped and/or damaged way.

A further drawback of the gripping head may be that the gripping finger may need means to lock the position of the products in particular during a movement to another location, wherein said means are adapted to the specific shape and/or size of the products. These means thus require a certain orientation of the product with respect to the gripping head. However, in case the products do not have the right orientation, the product may be damaged during gripping, or the orientation of the gripping head has to be adapted. Also, products with different sizes have to be gripped by different gripping heads which requires replacement of the gripping head or the means.

### SUMMARY OF THE INVENTION

It is an object of the invention to provide an improved system for displacing products.

The invention therefore provides a system for displacing products, comprising:

a conveyor for conveying a product in a conveying direction,

a gripping device having a moveable gripping head to displace the product from the conveyor to another location, said gripping head comprising:
a base,
at least one gripping finger moveably mounted to said base for movement between a gripping position for holding or supporting a first side of the product and an open position in which the product is able to pass the at least one gripping finger in a passing direction,
   wherein the at least one gripping finger is arranged such that it initially moves away from the product in the passing direction when moving from the gripping position to the open position.

It is explicitly mentioned here that this does not exclude a movement in another direction, for instance perpendicular to the passing direction. Meant is that the at least one gripping finger initially moves away from the product in a direction which has a non-zero component in the passing direction.

An advantage of the system is that the at least one gripping finger can be released, i.e. disengaged, from the product in the passing direction, thereby minimizing frictional forces on the product in a direction perpendicular to the passing direction, i.e. a lateral direction. As a result, a lateral movement of the product can be prevented, so that the position of the product is maintained during releasing. As mentioned before, a sideways motion of the gripping fingers is not excluded. It depends on the product and the stickiness between the product and the at least one gripping finger how much movement of the at least one gripping finger is allowed in the lateral direction without inducing lateral movement of the product or damage to the product during releasing. Preferably, the at least one gripping finger is moved in the passing direction at least until the product is released from the at least one gripping finger. After releasing, the at least one gripping finger may also move only sideways as there is no contact anymore between the at least one gripping finger and the product.

In an embodiment, an angle between the passing direction and the direction in which the at least one gripping finger initially moves from the gripping position to the open position is at most 80 degrees, preferably at most 60 degrees and more preferably at most 45 degrees.

A further advantage may be that due to the minimized frictional forces, the chances the product is damages are minimized and/or that mutual orientations of articles in a product are not altered.

In another embodiment, the conveyor comprises a supporting element, such as a conveyor belt, to support the product during conveying, wherein said supporting element comprises a recess below/under the supported product which extends outside the supported product to receive the at least one gripping finger of the gripping head, i.e. said supporting element comprises a recess to receive the at least one gripping finger of the gripping head while the supporting element supports a product above the recess.

An advantage is that the at least one gripping finger is able to easily get under the product, possibly without contact between the at least one gripping finger and the product, so that even in case of thin or small products, the products are not wrinkled or get clamped between gripping fingers. Preferably, the at least one gripping finger approaches the product from below and engages with the first side of the product while moving in a direction which has a non-zero component in the passing direction towards the product. Preferably, the trajectory of the at least one gripping finger during movement from the open position to the gripping position is substantially equal to the trajectory of the at least one gripping finger during movement from the gripping position to the open position.

Another advantage may be that because the frictional forces in the lateral direction are minimized also during gripping of the product, the product is not undesirably displaced or damaged in the lateral direction during gripping, which would lead to unpredictable positioning of the product.

It is possible that there is a recess in the supporting element for each gripping finger, but also an embodiment is envisaged wherein a recess is able to receive multiple gripping fingers. As walls of the recess and a supporting surface adjacent the recess usually have to support the product, it is preferred to have one recess per gripping finger to allow for narrow recesses and optimally support the product. In that case, the width of the at least one gripping finger is also small to fit into the recess.

In another embodiment, the recess extends all the way through the supporting element in a thickness direction of the supporting element perpendicular to the conveying direction, so that movement of the gripping finger is not limited by a bottom of the recess, which may be advantageous from motion control point of view. In other words, the supporting element is provided with an opening through which the at least one gripping finger may pass. In an embodiment, the supporting element comprises wires to support the product, so that the at least one gripping finger is able to pass between two wires, especially during movement from the open position to the gripping position. The wires preferably extend in the conveying direction of the conveyor.

The recess can be oriented in any direction, for instance at an angle of 90 degrees with respect to a conveying direction, i.e. perpendicular to a conveying direction of the conveyor.

In another embodiment, the conveyor comprises a lifting device to lift the device from the supporting element, said lifting device comprising a recess below the lifted product which extends outside the lifted product to receive the at least one gripping finger of the gripping head. An advantage is that the lifting device is able to keep the product stationary while the conveyor moves on. This may simplify the gripping action of the gripping head. By providing a recess in the lifting device, the at least one gripping finger is able to approach the product from below which minimizes the lateral forces applied to the product during gripping as mentioned before with respect to the recess in the supporting element.

The lifting device may also provide the possibility to choose between different orientations of the gripping head during gripping. The recess in the lifting device may therefore be at an angle with respect to the recess in the supporting element. A recess can limit the orientation of the at least one gripping finger to be parallel to a longitudinal direction of the recess. If in such a situation a product requires another orientation of the gripping head during gripping, the product may be lifted by a lifting device with a recess that extends in another direction.

Preferably, the lifting device comprises protrusions to extend through the recesses of the supporting element to lift the product.

In an embodiment, the lifting device is stationary with respect to the supporting element during lifting of the product by the lifting device, i.e. the lifting device moves along with the supporting element during lifting of the product. An advantage is that a motion of the product in the conveying direction is not disturbed during lifting. Another advantage may be that subsequent products on the conveyor do not interfere with each other due to the lifting or gripping, so the spacing between subsequent products can be minimized.

The invention further relates to a gripping head for gripping a product comprising:

a base,

at least one gripping finger moveably mounted to said base between a gripping position for holding a first side of the product and an open position in which the product is able to pass the at least one gripping finger in a passing direction,

wherein the at least one gripping finger is arranged such that it initially moves away from the product in the passing direction when moving from the gripping position to the open position.

In an embodiment, the gripping head further comprises at least one resilient element to engage with a second side opposite the first side of the product held by the at least one gripping finger, wherein the resilient element is resilient in a direction substantially parallel to the passing direction.

An advantage of the at least one resilient element is that during the handling of the object by the gripping head, the at least one resilient element is able to lock the position of the product with respect to the gripping head and also the mutual orientation of articles in case the product consists of multiple articles which are handled at the same time. This can also be done during gripping of the product by pressing the product against the conveyor with the at least one resilient element before the at least one gripping finger moves to the gripping position. After gripping, the product is clamped between the at least one gripping finger and the at least one resilient element, thereby locking the position of the product during transport to another location.

Another advantage is that the at least one resilient element can aid in the release of the product. This can for instance be done by accelerating the gripping head in the passing direction such that the product is pushed more against the resilient element due to its inertia and thereby loosens the contact between the product and the at least one gripping finger. In an extreme situation the first side of the product substantially disengages from the at least one gripping finger. By subsequently moving the at least one gripping finger to the open position minimal lateral forces are exerted to the product by the at least one gripping finger. As a result, the product can not be torn apart by this movement of the at least one gripping finger and the mutual orientation of products comprising multiple articles is maintained. The product may now be released from the at least one resilient element by decelerating the gripping head in the passing direction, so that the inertia of the product will cause disengagement of the second side of the product from the at least one resilient element. The product will then follow a predictable trajectory towards another location. Using the acceleration of the gripping head in releasing of the product may be useful for very sticky products.

In an embodiment, multiple resilient elements are provided in an array, preferably a two-dimensional array or grid. This has the advantage that the gripping head can adapt itself to any shape or size of the product. As the resilient elements are independent from each other, they are all able to engage with the second side, thereby optimally locking the position of the product. This in contrast to a single resilient element such as a resilient band or film, wherein it is not able to ensure that the entire surface of the resilient element engages with the second side.

If the resilient elements are also substantially rigid in a direction perpendicular to the passing direction, they are able to more effectively block a lateral movement of the product, especially when the product is smaller than an area formed by the array and outer resilient elements form a natural boundary for the product. So, when products have to be handled with different sizes or shapes, no replacement of the gripping head is required as long as the gripping head is large enough to grip the products. In other words, the resilient elements are flexible means which flexibly adapt to the shape and size of the product to lock the position of the product.

In another embodiment, the at least one resilient element is a tube-like element with two open ends, one end being mounted to the base and the other end being engageable with the second side of the product.

When an air transporting device, such as a pump or ventilator, is provided which is connected to the open end of the at least one resilient element that is connected to the base, it is possible to transport air from or to the at least one resilient element, thereby allowing to suck the product against the at least one resilient element during gripping and motion to another location, and/or blow the product away during releasing of the product, which may be advantageous for very sticky products.

Alternatively, the at least one resilient element is a tube-like element with an open end and a closed end, the open end being mounted to the base, and the closed end being engageable with the second side of the product. With the closed end, the product is not able to contaminate the interior of the at least one resilient element, and if the at least one resilient element is connected to the air transporting device mentioned before, a spring stiffness of the at least one resilient element can be controlled by the amount of air, i.e. the pressure, inside the at least one resilient element.

In a further embodiment, the at least one resilient element is adjustably mounted to the base in the passing direction. This allows the gripping head to adjust itself to different shapes of products and/or set a pressure exerted to the product by the at least one resilient element, i.e. control a clamping force of the gripping head.

The at least one gripping finger may be pivotable about an axis perpendicular to the passing direction. In this way, a single actuation action is able to move the at least one gripping finger from the open position to the gripping position and vice versa, and respectively depart from or end at the product in a direction substantially in the passing direction. Furthermore, the pivoting movement allows for efficiently moving the at least one gripping finger away from the product and out of the way of the product which will move in the passing direction.

In yet another embodiment, the at least one gripping finger comprises a protrusion on the side which is configured to hold the first side of the product. This will further aid in locking the position of the product. The protrusion may be located such that in the gripping position the protrusion is positioned between multiple resilient elements or is in line with the at least one resilient element.

In another embodiment, the gripping head is extended in a direction perpendicular to the passing direction to be able to grip multiple products at a time, which is advantageous from throughput point of view. When the at least one gripping finger is pivotable about an axis perpendicular to the passing direction, the gripping head is preferably extended parallel to said axis.

The invention also relates to a method for displacing a product with a gripping head as mentioned above. The method comprises the following steps:

a) moving the at least one gripping finger to the open position when the at least one gripping finger is in the gripping position;
b) moving the gripping head towards the product in the passing direction such that the product passes the at least one gripping finger;
c) moving the at least one gripping finger to the gripping position such that the at least one gripping finger holds a first side of the product;
d) moving the gripping head to another location;
e) moving the at least one gripping finger away from the product to the open position with an initial acceleration of more than 5 m/s² in the passing direction with respect to the product to disengage the at least one gripping finger from the product.

In an embodiment, the at least one gripping finger has an initial acceleration of at least 7.5 m/s² in the passing direction with respect to the product to disengage the at least one gripping finger from the product in step e). More preferably, an acceleration of more than 1 g is provided in step e).

The initial acceleration can be provided by operating the at least one gripping finger only, but also a combination is possible as mentioned before, wherein the at least one gripping finger is operated while the gripping head accelerates in the passing direction, thereby aiding in getting a predetermined acceleration with respect to the product.

In an embodiment, the passing direction is a substantially vertical direction. In this way, full advantage can be made from gravity which aids in releasing the product and will not act as a disturbance force.

### BRIEF DESCRIPTION OF THE DRAWINGS

The invention will now be described in a non-limiting way with respect to the drawings in which like numbers refer to like parts. In the drawings:

FIG. 1 depicts a system according to an embodiment of the invention seen from above;

FIG. 2A-2C depict a gripping head according to an embodiment of the invention;

FIG. 3 depicts in cross sectional side view a detail of a system according to a further embodiment of the invention;

FIG. 4 depicts another side view of the system of FIG. 3;

FIG. 5 depicts a side view and a cross sectional view of a conveyor and lifting device of a system according to another embodiment of the invention in a non-lifted position;

FIG. 6 depicts a side view and cross sectional view of the conveyor and lifting device of FIG. 5 in a lifted position; and

FIG. 7 depicts a side view of a conveyor and lifting device of a system according to yet another embodiment of the invention.

### DETAILED DESCRIPTION OF THE INVENTION

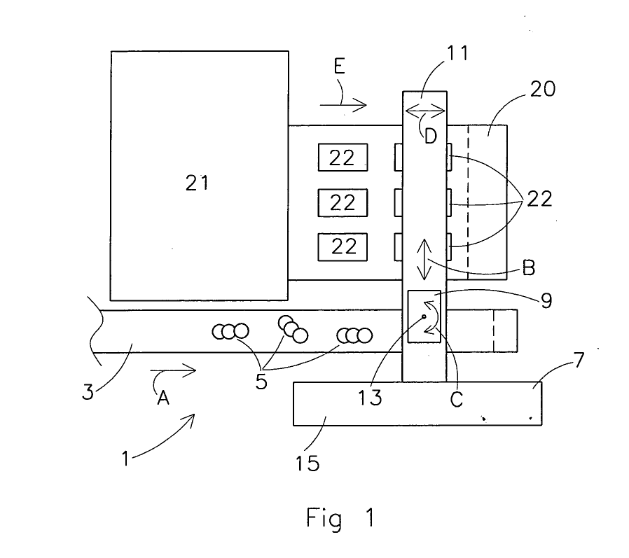

FIG. 1 depicts a system 1 according to an embodiment of the invention seen from above. The system 1 comprises a conveyor 3 for conveying products 5, and a gripping device 7. The conveyor conveys the products 5 in a conveying direction A.

The gripping device 7 comprises a gripping head 9 to displace the product 5 from the conveyor 3 to another location, for example another conveyor or storage crate. The gripping head 9 is moveably connected to an arm 11 of the gripping device 7, wherein the gripping head is able to translate in a direction B and to rotate in a direction C about a vertical axis 13 with respect to the arm 11. The arm 11 is moveably connected to a stationary base 15 of the gripping device and is able to translate the arm 11 in a direction D with respect to the stationary base 15. The gripping head 9 is thus positionable in at least three degrees of freedom B, C, D. Preferably, the gripping head can also be positioned in a vertical direction (not shown).

The system further comprises a second conveyor 20 for conveying trays 22 in a conveying direction E parallel to conveying direction A. The trays 22 are formed in a tray forming apparatus 21 and the gripping device 7 is configured to displace the products 5 from the conveyor 3 to the trays 22 on conveyor 20, for instance for packaging reasons.

Here, a product 5 consists of multiple articles and may for instance be a sliced meat product or other food product. It is important that the products are accurately placed in the trays, wherein preferably the mutual orientation of the articles of the product remains the same, i.e. unchanged, despite the relocation of the product. As can be seen from FIG. 1, not all products may be aligned perfectly. In this example, the middle product 5 is rotated about a vertical axis with respect to the other products 5. The system may therefore comprise a detection system, such as a camera, to detect the orientation of a product, wherein said detection system is connected to a control system of the gripping device. The control system is then able to adjust movement of the gripping device, in particular the movement of the gripping head, in dependency of an output of the detection system. For instance, the gripping head may be rotated prior to gripping to adjust itself to the misalignment of the middle product 5 or may grip the product normally and rotate before releasing the product to compensate for the misalignment.

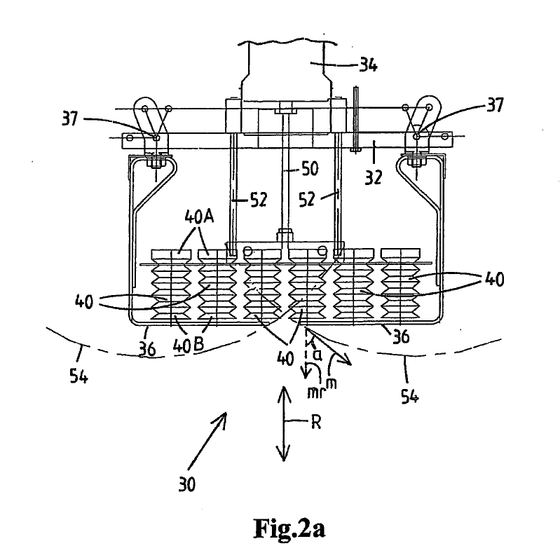

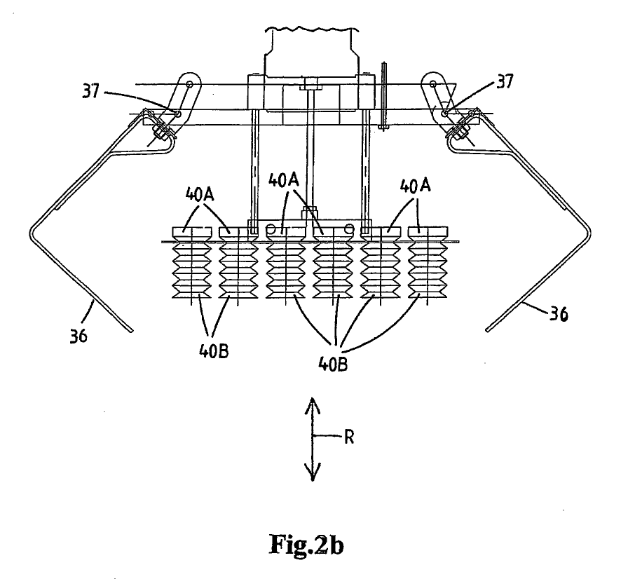

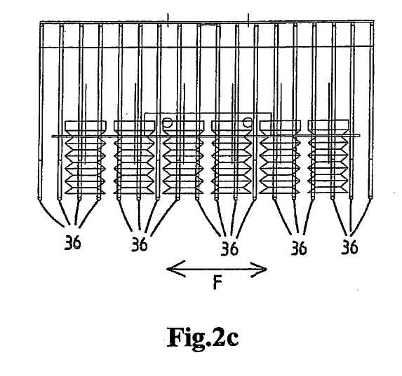

The gripping device 7 comprises a gripping head according to an embodiment of the invention, an example of which will be described with reference to FIGS. 2A-2C.

It is to be understood by the skilled person that there exist many other configurations for the system of FIG. 1. The gripping device as well as the conveyors may be oriented in different ways or may be based on different working principles. They will not be described here as they are apparent to the skilled person.

FIGS. 2A-2C depict a gripping head 30 according to an embodiment of the invention which is suitable for a system according to FIG. 1. The gripping head comprises a base 32 to mount the gripping head 30 to a part 34 of a gripping device (not shown). The gripping head further comprises multiple gripping fingers 36 moveably mounted to the base 32. The gripping fingers 36 are pivotable about a pivot axis 37 between a gripping position as shown in FIG. 2A for holding a first side of a product and an open situation as shown in FIG. 2B in which the product is able to pass the multiple gripping fingers 36 in a passing direction R. FIG. 2C shows a partial side view of the gripping head 30 of FIG. 2A.

The gripping head also comprises multiple resilient elements 40 arranged in a two-dimensional array to engage with a second side of the product, opposite the first side of the product, which first side is held by the multiple gripping fingers, wherein the resilient elements are resilient in a direction substantially parallel to the passing direction R.

It can be clearly seen from FIGS. 2A and 2C that in the situation that the gripping head is not gripping a product and the gripping fingers are in the gripping position, the gripping fingers and the resilient elements form two flat gripping planes between which the product can be gripped. The two flat gripping planes are parallel to each other. When a product is gripped by the gripping head, the gripping plane of the resilient elements may deform to adjust itself to the shape and size of the product.

The resilient elements are tube-like elements with two open ends 40A, 40B, one end 40A being mounted to the base 32 and the other end 40B being engageable with the second side of the product. The resilient elements 40 comprise wall sections that may fold into each other like a harmonica to provide the necessary resiliency. The open ends 40A may be connected to an air transporting device such as a pump or ventilator (not shown) to suck or blow air through the resilient elements.

The resilient elements 40 are in this embodiment adjustable in the passing direction R by operating rod 50. The gripping head also comprises guiding rods 52 to guide movement of the resilient elements in the passing direction R.

FIG. 2C clearly shows the multiple gripping fingers 36 spaced at a distance from each other. Each gripping finger is able to be received in a recess of a supporting element which supports the product. The array of resilient elements and the number of gripping fingers can easily be extended in a direction F, which is parallel to the pivot axis 37, for instance to allow multiple products to be gripped at the same time.

In FIG. 2A two trajectories 54 are shown which describe the path of the free end of the gripping fingers 36 from the open position to the gripping position and vice versa due to the rotation about pivot axis 37. An initial direction of the free end of the gripping fingers is indicated by arrow M. This initial direction M has a non-zero component in the passing direction as is indicated by dashed arrow Mr. The angle α between the initial direction M and the passing direction R is preferably as small as possible, especially in case of very sticky products. The initial direction M depends on the location of pivot axis 37.

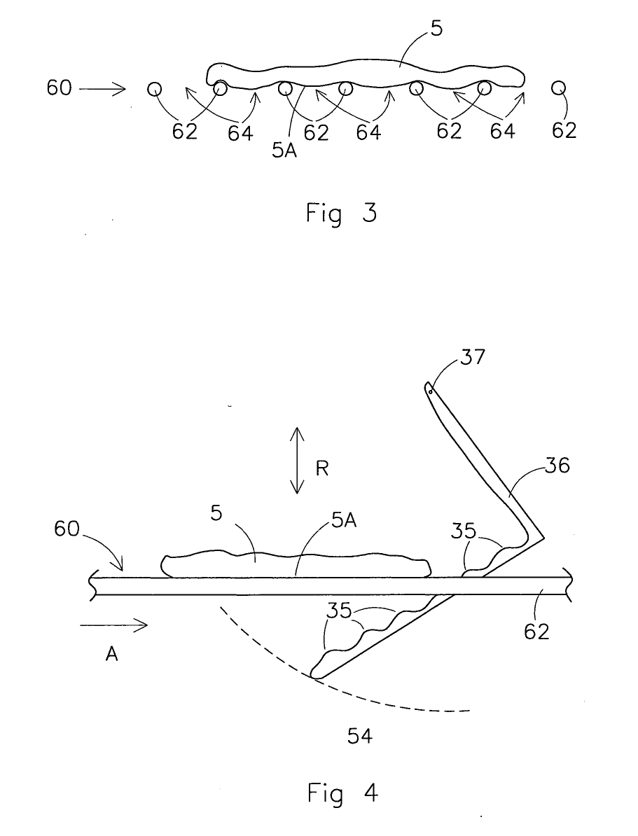

The gripping head of FIG. 2 can be used in combination with a supporting element 60 as shown in cross section in FIG. 3 and in side view in FIG. 4. The supporting element 60 can be a conveyor belt and is configured to support a product 5 for conveyance in a conveying direction A as shown in FIG. 4. The supporting element 60 comprises recesses or openings 64 which extend all the way through the supporting element 60 in a thickness direction perpendicular to the conveying direction and parallel to the passing direction and thereby form multiple wires 62. The recesses extend below and beyond the perimeter of the product (seen from above) to receive a gripping finger 36. As an example, a single gripping finger 36 is shown in FIG. 4.

The gripping finger 36 is pivotable about a pivot axis 37 extending perpendicular to a passing direction R. The gripping finger 36 will first be in an open position in which the product 5 may pass the gripping finger 36 in a passing direction R. The gripping head is subsequently moved towards the product in the passing direction, such that the gripping finger extends into the recess 64 between the wires 62 and approaches the product from below. A non-shown resilient element may be pressed against the product to lock a position of the product. The gripping finger is subsequently moved, see arrow F from the open position to a gripping position in which it engages with a first surface 5A of the products and holds the product. The gripping finger 36 of FIG. 4 is shown somewhere in between the open position and the gripping position. Preferably, no lateral forces, i.e. forces perpendicular to passing direction R, are exerted on product 5 during gripping of the product by the gripping finger. To show the movement of the gripping finger, a trajectory 54 of the free end of the gripping finger is shown in FIG. 4, showing that the gripping finger ends at the product 5 in a direction which has a non-zero component in the passing direction towards the product.

In this embodiment, the gripping finger 36 comprises protrusions 35 to engage with the product 5 during gripping and further prevent the product from moving sideways.

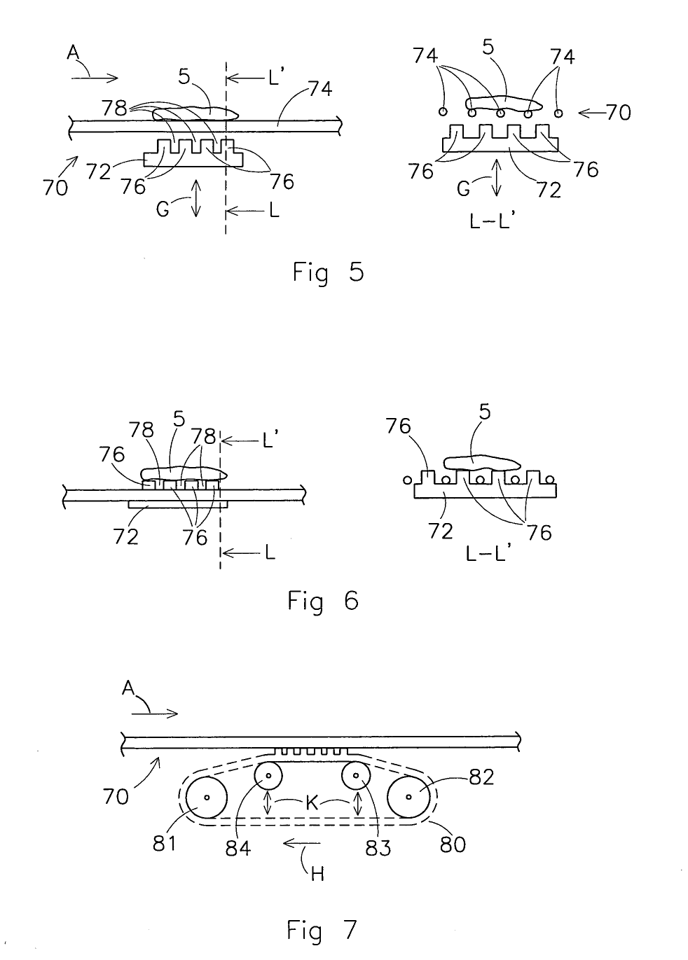

FIG. 5 depicts a side view and a cross sectional view of a conveyor and lifting device 72 of a system according to another embodiment of the invention in a non-lifted position. The conveyor comprises a supporting element 70 consisting of multiple wires 74 to support a product 5 and convey the product in a conveying direction A.

The lifting device 72 comprises protrusions 76 which can extend through the gaps in between the wires 74. The lifting device 72 is moveable in a direction G perpendicular to the supporting element and conveying direction A. The lifting device comprises recesses 28 extending perpendicular to the conveying direction A. The recesses 28 extend below and outside the product to receive a gripping finger of a gripping head.

FIG. 6 shows the conveyor and lifting device 72 in the lifted position. The protrusions 76 extend through the supporting element such that the product is lifted from the supporting element and is fully supported by the lifting device. The recesses 78 now also extend above the supporting element, so that they can receive a gripping finger at an angle to the wires of the supporting element, in particular perpendicular to the conveying direction.

It is thus possible to choose between a first orientation of the gripping head wherein the gripping fingers can pass the wires to approach the product from below, or a second orientation rotated 90 degrees with respect to the first orientation wherein the gripping fingers can be received in the recesses 78 to approach the product from below.

FIG. 7 shows an alternative lifting device comprising a flexible belt 80 with protrusions similar to the protrusions 76 of lifting device 72 in FIGS. 5 and 6. Only a few protrusions are drawn explicitly. The belt 80 is running over four pulleys 81, 82, 83, 84 in an endless fashion in direction H, which corresponds to a conveying direction A of conveyor 70. Preferably, the speed of the belt 80 is the same as the speed of the conveyor 70.

The pulleys 83 and 84 are adjustable in a direction perpendicular to the conveyor as indicated by arrows K. By moving the pulleys 83 and 84 towards the conveyor it is possible to extend the portion of belt 80 between the two pulleys through the conveyor 70 and lift a product supported by the conveyor 70 similar to the lifting device of FIGS. 5 and 6. As the speed of the belt 80 is preferably equal to the speed of the conveyor, the belt 80 between the pulleys 83 and 84 is stationary with respect to the conveyor 70 during lifting of the product which minimizes forces on the product during lifting.

1. A system for displacing products comprising:
a conveyor for conveying a product in a conveying direction; and
a gripping device having a moveable gripping head to displace the product from the conveyor to another location, said gripping head comprising:
a base; and
at least one gripping finger moveably mounted to said base for movement between a gripping position for holding a first side of the product and an open position in which the product is able to pass the at least one gripping finger in a passing direction,
wherein the at least one gripping finger is arranged such that it initially moves away from the product in the passing direction when moving from the gripping position to the open position.

2. The system according to claim 1, wherein the conveyor comprises a supporting element to support the product during conveying, said supporting element comprising a recess to receive the at least one gripping finger of the gripping head while the supporting element supports a product above the recess.

3. The system according to claim 2, wherein the recess extends all the way through the supporting element in a thickness direction of the supporting element perpendicular to the conveying direction.

4. The system according to claim 2, wherein the recess extends in a direction perpendicular to the conveying direction of the conveyor.

5. The system according to claim 1, wherein the conveyor comprises a lifting device to lift the product from the supporting element, said lifting device comprising a recess to receive the at least one gripping finger of the gripping head while lifting the product.

6. The system according to claim 5, wherein the lifting device comprises a protrusion to extend through the recess of the supporting element to lift the product.

7. The system according to claim 5, wherein the recess in the lifting device is at an angle with respect to the recess in the supporting element.

8. The system according to claim 5, wherein the lifting device is moveable along with the supporting element in the conveying direction at least during lifting.

9. A gripping head for gripping a product comprising:
a base; and
at least one gripping finger moveably mounted to said base for movement between a gripping position for holding a first side of the product and an open position in which the product is able to pass the at least one gripping finger in a passing direction;
wherein the at least one gripping finger is arranged such that it initially moves away from the product in the passing direction when moving from the gripping position to the open position.

10. The gripping head according to claim 9, wherein the gripping head further comprises at least one resilient element to engage with a second side opposite the first side of the product held by the at least one gripping finger, wherein the at least one resilient element is resilient in a direction substantially parallel to the passing direction.

11. The gripping head according to claim 10, wherein multiple resilient elements are provided in an array.

12. The gripping head according to claim 10, wherein multiple resilient elements are provided in a two-dimensional array.

13. The gripping head according to claim 10, wherein the at least one resilient element is a tube-like element with two open ends, one end being mounted to the base and the other end being engageable with the second side of the product.

14. The gripping head according to claim 10, wherein the at least one resilient element is a tube-like element with an open end and a closed end, the open end being mounted to the base and the closed end being engageable with the second side of the product.

15. The gripping head according to claim 13, comprising an air transporting device, such as a pump, connected to the open end of the at least one resilient element which is connected to the base to transport air from or to the at least one resilient element.

16. The gripping head according to claim 10, wherein the at least one resilient element is adjustably mounted to the base in the passing direction.

17. The gripping head according to claim 9, wherein the at least one gripping finger is pivotable about an axis perpendicular to the passing direction.

18. The gripping head according to claim 9, wherein the at least one gripping finger comprises protrusions to engage with the first side of the product.

19. The gripping head according to claim 9, wherein the gripping head is extended in a direction perpendicular to the passing direction to be able to grip multiple products at a time.

20. A method for displacing a product with a gripping head according to claim 9, said method comprising the following steps:
a) moving the at least one gripping finger to the open position when the at least one gripping finger is in the gripping position;
b) moving the gripping head towards the product in the passing direction such that the product passes the at least one gripping finger;
c) moving the at least one gripping finger to the gripping position such that the at least one gripping finger holds a first side of the product;
d) moving the gripping head to another location; and
e) moving the at least one gripping finger away from the product to the open position with an initial acceleration of more than 5 m/s² in the passing direction with respect to the product to disengage the at least one gripping finger from the product.
